(19) United States
(12) Patent Application Publication
(10) Pub. No.: US 2008/0279198 A1
(43) Pub. Date: Nov. 13, 2008

(54) Method for the Transmission of Information in a Communication System Using a Path

(76) Inventors: Ingo Gruber, Munchen (DE); Hui Li, Beijing (CN)

Correspondence Address: STAAS & HALSEY LLP, SUITE 700, 1201 NEW YORK AVENUE, N.W., WASHINGTON, DC, 20005, US

(21) Appl. No.: 10/577,661

(22) PCT Filed: Sep. 8, 2004
(86) PCT No.: PCT/EP04/52088

§ 371 Date: May 1, 2006

(30) Foreign Application Priority Data
Oct. 31, 2003 (DE) 103 50 891.0

(51) Int. Cl. H04L 12/28

(52) U.S. Cl. 370/400

(57) ABSTRACT

A method transmits information in a communication system with a number of nodes. At least one node receives a message including the details of a path, running from a source node, though the at least one node, to a target node. The at least one intermediate node, using the details of the at least one path, stores identification information concerning the nodes, adjacent to the at least one node, along the at least one path and transmits the message further along the at least one path. A node in the communication system is also described.

### CROSS REFERENCE TO RELATED APPLICATIONS

This application is based on and hereby claims priority to PCT Application No. PCT/EP2004/052088 filed on Sep. 8, 2004 and German Application No. 10350891.0 filed on Oct. 31, 2003, the contents of which are hereby incorporated by reference.

### BACKGROUND OF THE INVENTION

The invention relates to a method for transmitting information in a communication system having a plurality of nodes. The invention also relates to a node in a communication system.

A multiplicity of different types of communication system are known for communicating or transmitting information. In radio communication systems, for example, information (such as voice, image information, video information, SMS (Short Message Service), MMS (Multimedia Messaging Service) or other data) is transmitted using electromagnetic waves via a radio interface between source node and destination node. Depending on the actual configuration of the radio communication system, the nodes of a radio communication system can comprise various types of subscriber radio stations, radio access points or base stations. In this case, the emission of the electromagnetic waves takes place using carrier frequencies which lie in the frequency band which is provided for the relevant system.

Radio communication systems are often designed as cellular systems, e.g. in accordance with the standard GSM (Global System for Mobile Communication) or UMTS (Universal Mobile Telecommunications System), having a network infrastructure including e.g. base stations, entities for monitoring and controlling the base stations, and other network-based entities. In addition to this wide-area (supralocal) cellular hierarchical radio communication system, there also exist wireless local networks (WLANs, Wireless Local Area Networks) having a radio coverage area which is generally much more limited. Having a diameter of up to several hundred meters, the cells which are covered by the radio access points (AP: Access Point) of the WLANs are small in comparison with normal mobile radio cells. Examples of different standards for WLANs are HiperLAN, DECT, IEEE 802.11, Bluetooth and WATM.

In an ad hoc mode of a radio communication system, radio stations can communicate with each other via one or more hops (hop or multihop) without a requirement for intermediate connection of switching entities such as base stations or radio access points, for example. If a radio station anticipates the transmission of data to another radio station outside of its radio coverage area, as is often the case e.g. in an ad hoc mode, it is first necessary to determine a path between the radio station as the source node and the data recipient as the destination node. A path runs via one or more nodes which forward information during a data transmission between source node and destination node. In a radio communication system, therefore, the nodes of the path are in each case adjacent radio stations which are able to communicate directly with each other via radio.

A method which is often used for decentralized path determination (routing) in a communication system is the DSR (Dynamic Source Routing) method. In this context, the nodes of the communication system determine a path between a source node and a destination node, wherein both the source node and the destination node know one or more complete paths as a result of the method. Each of the messages sent from the source node to the destination node then includes the specification of a path which has been determined, such that the nodes of the path are able to forward the message in accordance with the path specification. However, the specification in each message of the path to be used represents a significant signaling overhead and therefore represents an inefficient utilization of the normally scarce transmission resources.

An alternatively used routing method is the AODV (Ad-hoc On-demand Distance Vector Routing) method, as a result of which the source node and destination node do not know the complete path, but merely their adjacent nodes along the path in each case. Moreover, after completion of the path determination, each node of the path knows its adjacent nodes along the path such that, when a message is transmitted from the source node to the destination node, the message does not contain a specification of the path to be used. The AODV method has the disadvantage that it is not possible to use a plurality of paths alternatively. In the event that the determined path can no longer be used for message transmission, a new method for path determination must be carried out instead. In terms of resources, however, it is more economical to obtain a plurality of paths as a result of a path determination, in order that the determined paths can be used for a longer time.

### SUMMARY OF THE INVENTION

The method addresses the problem of proposing a method which allows messages to be transmitted between a source node and a destination node of a communication system in a manner which is economical in terms of transmission resources. A node for carrying out the method is also set forth.

In the method for transmitting information in a communication system having a plurality of nodes, at least one node receives a message including the specification of at least one path which runs from a source node via the at least one node to a destination node. The at least one node uses the specification of the at least one path to store identification information relating to the two adjacent nodes, along the at least one path, of the at least one node. Furthermore, the at least one node forwards the message along the at least one path.

The communication system can be a radio communication system, for example, but it can also be a line-based communication system. The nodes of the communication system are embodied in accordance with the communication system, and in a radio communication system the nodes can be e.g. subscriber radio stations, repeaters or other network-based entities.

A path within the communication system runs from a source node to a destination node in each case. When a message is transmitted via the path, the source node is the sender of the message and the destination node is the addressed recipient of the message. A path therefore includes a source node and a destination node, as well as the other nodes of the path which forward information between source node and destination node. The specification of a path can therefore include a notification of source node, destination node and path nodes via which the path runs.

According to the method, a message is used which includes the specification of at least one path and can therefore be designated as a path message. In addition to the specification of the at least one path, the path message can however also contain other information such as user information and/or signaling information, for example.

The at least one node which receives the path message stores identification information relating to its adjacent nodes along the path. This identification information can be taken from the path message directly or indirectly by the at least one node. If the path runs via only one node, the adjacent nodes of this node will be the source node and the destination node. If the path has a plurality of nodes, the adjacent nodes can be either the source node and a further node or two further nodes or a further node and the destination node of the path. The identification information allows the node unambiguously to address that node, at least in its immediate environment, to which the identification information relates. However, it is also possible for the identification information to allow an unambiguous addressing of the relevant node within parts or the whole of the communication system. The identification information can be assigned to the relevant node temporarily or permanently.

In a development, the message including the specification of the at least one path is sent from the source node of the at least one path. The original sender of the path message is therefore the source node of the path. The at least one node, which receives the path message and stores the identification information relating to its adjacent nodes accordingly, can receive the path message either directly from the source node or from another node which forwards the path message.

It is advantageous if at least one further message, which does not include any specifications of the path that is to be used for transmitting the at least one further message, is transmitted from the source node to the destination node via the at least one path using stored identification information. On the basis of the previous storage of identification information relating to the nodes of at least one path, messages can now be transmitted via this at least one path without these messages having to contain a specification of the path that is to be used.

According to a development, following a failed transmission of the further message from the source node via the at least one path to the destination node, wherein said further message does not include any specifications of the path that is to be used for transmitting, a message including the specification of the at least one path is sent from the source node of the at least one path. A failed transmission means that the relevant message does not reach the destination node. The transmission of the further message, which does not include a specification of the path to be used, has failed and was therefore not fully completed and at best was only partially completed. As a result of the failed transmission, a path message is sent again. In addition to the specification of the path, this path message advantageously includes the content of the message whose transmission failed.

The at least one path was preferably determined with the assistance of an entity which is aware of relationships between adjacent nodes of the communication system. In a radio communication system, such an entity can be e.g. a base station or an entity which is connected to a base station. The entity determines the path in particular at the request of the source node. Following the determination of the path, the entity can then send specifications of the determined path to the source node, whereupon this source node inserts the specifications of the path in a path message and sends the path message to its adjacent node along the path. As an alternative to centrally determining the path by an entity using the network topology in this way, the at least one path can also be determined by nodes which have no information about the topology of the overall network. One example of this is the path determination by peer nodes in an ad hoc system, e.g. in accordance with a DSR method.

In an embodiment, all nodes via which the at least one path runs receive the message containing the specification of the at least one path. Moreover, these nodes store identification information relating to their two adjacent nodes along the path in each case. In particular, all nodes of the path consecutively receive the path message as a result of the path message being forwarded by their preceding node along the path in each case.

It is advantageous that the at least one node receives a message including the specification of a plurality of paths running via the at least one node and stores identification information about the two nodes which in each case are adjacent, along the plurality of paths, to the at least one node. The path message contains a specification of a plurality of paths in this case, whereupon after receiving the path message the at least one node stores a plurality of pairs of nodes which are adjacent, along a path, to it in each case. As an alternative to using a path message which includes the specification of a plurality of paths, it is also possible to use a plurality of path messages which contain the specification of a path in each case. The specification of a plurality of paths, irrespective of whether this takes place in one or a plurality of path messages, has the advantage that in the event of transmission difficulties along a path, a different path can be used for transmitting messages.

In a development the at least one node, after receiving a message which was directed from the source node to the destination node of the at least one path from a node about which it has not stored any identification information as an adjacent node along the at least one path, stores identification information about this node as an adjacent node along the at least one path. In this case, the at least one node recognizes that it has received a message, which is to be sent from the source node to the destination node, from a different node than that which it has stored as an adjacent node along the path between source node and destination node. As a result of this, the at least one node stores identification information about this node, which was unknown to it as an adjacent node along the path, wherein this new identification information can overwrite the previously stored identification information about the adjacent node on the side of the source node with reference to the path between source node and destination node. The new identification information can be used for addressing the adjacent node when forwarding or sending a message to the source node.

The at least one node, after receiving a specification of a further path, which further path is different from the at least one path and runs between the at least one node and the destination node, preferably stores identification information about the adjacent node, along the further path, of the at least one node. In this case, the at least one node stores identification information about a new adjacent node, along a further path, in the direction of the destination node. This new identification information can overwrite the previously stored identification information relating to the adjacent node in the direction of the destination node, with reference to at least one path between source node and destination node. The new identification information can be used for addressing when subsequently forwarding information to the destination node. This procedure corresponds to an update of the path to be used in the case of a message transmission from the source node to the destination node. The specification of the further path can be received by the at least one node from an entity which has an overview of the network topology.

The inventors propose a node having a receiver to receive a message including the specification of at least one path which runs from a source node via the node to a destination node. The node also has: a memory to store identification information relating to the two adjacent nodes, along the at least one path, of the at least one node, and a transmitter to forward the message along the at least one path.

In a development, the node also has a memory to store identification information about a node, from which it receives a message that was directed from the source node to the destination node of the at least one path, and in relation to which node it has not stored any identification information as an adjacent node along the at least one path, as an adjacent node along the at least one path.

In accordance with a configuration, the node also has: a receiver to receive a specification of a further path between the node and the destination node, said further path being different from the at least one path, and a memory to store identification information about a node as an adjacent node along the further path.

In a communication system, the node is particularly suitable for carrying out the method described above.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic representation of a first execution of a method according to one embodiment of the invention in a communication system,

FIG. 2 shows a schematic representation of a second execution of a method according to one embodiment of the invention in the communication system as per FIG. 1,

FIG. 3 shows a schematic representation of a third execution of a method according to one embodiment of the invention in the communication system as per FIG. 1,

FIG. 4 shows a schematic representation of a fourth execution of a method according to one embodiment of the invention in the communication system as per FIG. 1, and

FIG. 5 shows a schematic representation of a fifth execution of a method according to one embodiment of the invention in the communication system as per FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

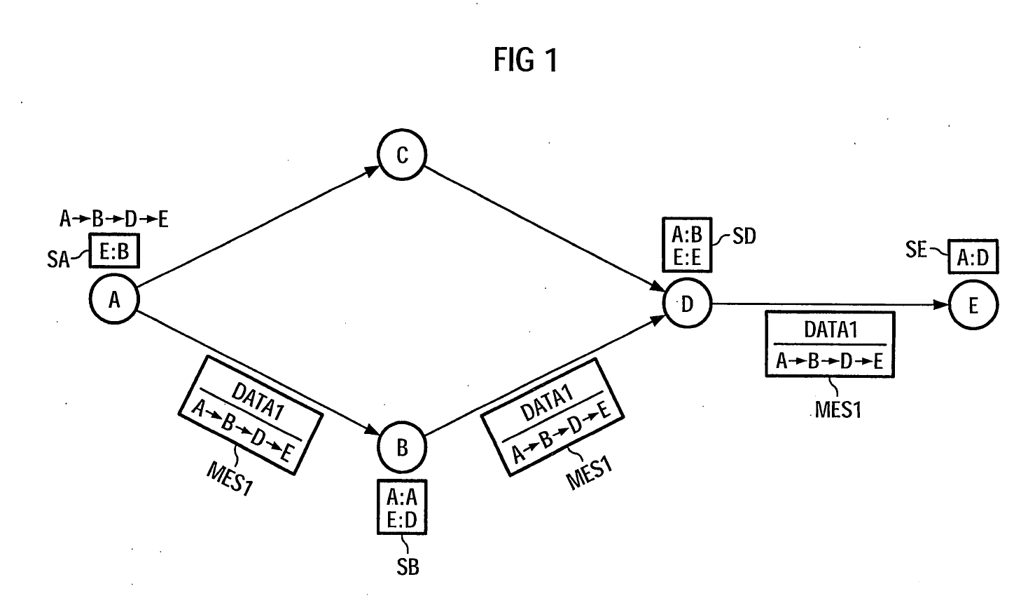

A communication system has the nodes A, B, C, D and E is illustrated in FIG. 1. In the following, node A is the source node which intends to transfer messages to node E, which is therefore the destination node in the following. The nodes, which can communicate directly with each other in each case, are connected by lines or arrows. Since a direct communication between the source node A and the destination node E is not possible, a path between the source node A and the destination node E must be determined before the message transmission. One possible path between the source node A and the destination node E runs via the nodes C and D, and another path runs via the nodes B and D.

The communication system can be a cellular mobile radio communication system, for example, in which it is required to determine a path between a subscriber mobile station and a base station which is outside of the radio range of the mobile station. Alternatively, the destination node can also be a radio access point of a WLAN, for example. It is also possible for the nodes A, B, C, D and E to represent radio stations of an ad hoc system.

In FIG. 1, it is assumed that the path A→B→D→E to the destination node E is known to the source node A. The source node A might have obtained this knowledge e.g. as a result of a preceding DSR method. In this context, the source node A sends out a request via broadcast for path determination between the source node A and the destination node E, wherein the request contains identification information relating to the source node A. This request is then flooded through the communication system. Each node which receives the request appends its own identification information and forwards the request via broadcast. The request finally reaches the destination node, which therefore knows the complete path. It sends a reply along the path which has been determined. For this, the reply includes the specification of the determined path, such that the nodes of the path know to which node they must forward the reply. The reply finally reaches the source node A, which therefore knows the complete path. According to this method, a plurality of alternative paths can be determined by one request, if a plurality of requests reach the destination node E via different paths. The nodes of the determined path or paths do not know the determined paths, and therefore each message which is sent from the source node A to the destination node E must include the specification of the path in order that the nodes can extract from this specification the node to which the message must be forwarded.

As an alternative to the described method of decentralized path determination, it is also possible for an entity, e.g. a network-based entity of a cellular radio communication system, to define the path at the request of the source node A. For this, the entity uses network topology knowledge which it received previously from the nodes. Specifications relating to the path which has been defined are then sent to the source node A.

In FIG. 1, the source node A sends a message MES1 having of information DATA1 and the specification of the path A→B→D→E to the node B. This stores identification information relating to its adjacent node in the direction of the source node A, i.e. the source node A, and its adjacent node in the direction of the destination node E, i.e. the node D, in a memory SB. The node B then forwards the message MES1 to its adjacent node in the direction of the destination node E, i.e. the node D. This stores identification information relating to its adjacent node in the direction of the source node A, i.e. the node B, and its adjacent node in the direction of the destination node E, i.e. the node E, in a memory SD. The node D then forwards the message MES1 to the destination node E, which stores identification information relating to its adjacent node in the direction of the source node A, i.e. the node D, in a memory SE. The source node A also stores identification information relating to its adjacent node in the direction of the destination node E, i.e. the node B. Consequently, both the source node A and the destination node E, as well as the nodes B and D of the path, know their adjacent nodes for the next hop in the direction of source node A and/or in the direction of destination node E. The relevant identification information relating to the adjacent nodes is extracted by the nodes B, D and E from the specification of the path A→B→D→E in the message MES1.

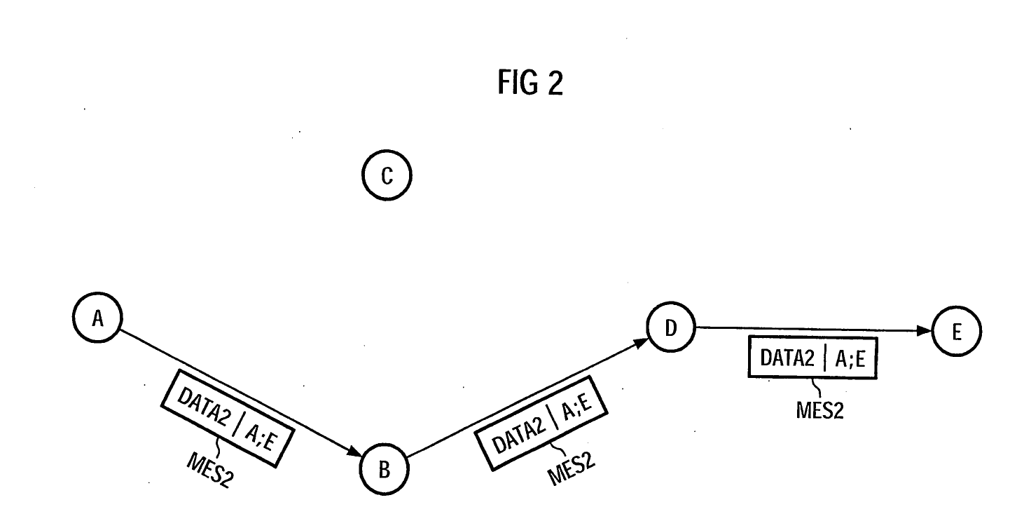

FIG. 2 shows the transmission of a message MES2 from the source node A to the destination node E. In this context, the message MES2 contains information DATA2 and identification information relating to the source node A and the destination node E. The specification of the destination node E is necessary because, on the basis of this information, the nodes B and D decide to which nodes the message MES2 is forwarded. The specification of the source node A is advantageous for error reports which might occur. The message MES2 does not include a specification of the path which must be used for the transmission of the message MES2. This results in an economy of transmission resources, since the information DATA2 share of the total size of the message MES2 is bigger than e.g. the information DATA1 share of the total size of the message MES1. On the basis of the message MES2, the nodes B and D of the path A→B→D→E recognize that the message MES2 is destined for the destination node E. Since the nodes B and D have stored identification information relating to the respective adjacent nodes D and E along the path A→B→D→E, they forward the message MES2 in accordance with the stored identification information.

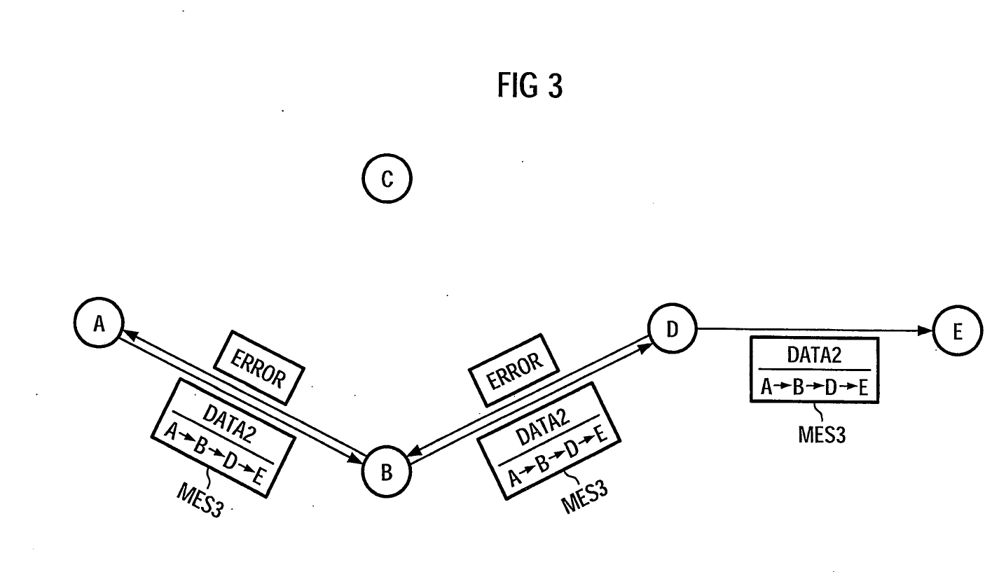

A problem arises if the message MES1 containing the specification of the path A→B→D→E is lost, i.e. if the message MES1 is not received by all nodes B and D of the path. In FIG. 3, it is assumed that the transmission of the message MES1 failed between the nodes B and D. Consequently, the node D has not stored any identification information relating to the adjacent node along the path A→B→D→E. This means that if the node D receives the message MES2 from the source node A for the destination node E, the node D does not know to which node the message MES2 must be forwarded. If the node D receives such a message which is addressed to the destination node E, without said message containing specifications relating to the path which must be used, the node D generates an error report ERROR which is sent back to the source node A via the node B. For this, it is advantageous if the message contains a data field which allows the node D to identify the node from which it received the message, i.e. the node B. This ensures that a valid path exists, which can be used for sending the error report ERROR, back to the source node A. Such data fields should be implemented in particular when transmitting the first message via a path, which message does not contain any specifications about this path which is to be used.

Following receipt of the error report ERROR, the source node A sends a message MES3 containing the information DATA2, during whose transmission an error occurred, and the specification of the path A→B→D→E. The nodes B, D and E can then store identification information relating to their adjacent nodes along the path, as illustrated in FIG. 1. Renewed storage by the node B is not necessary, however, since this node has already stored identification information relating to its adjacent nodes when the message MES1 was sent. The next message can then once again be sent from the source node A without specifying the path to be used.

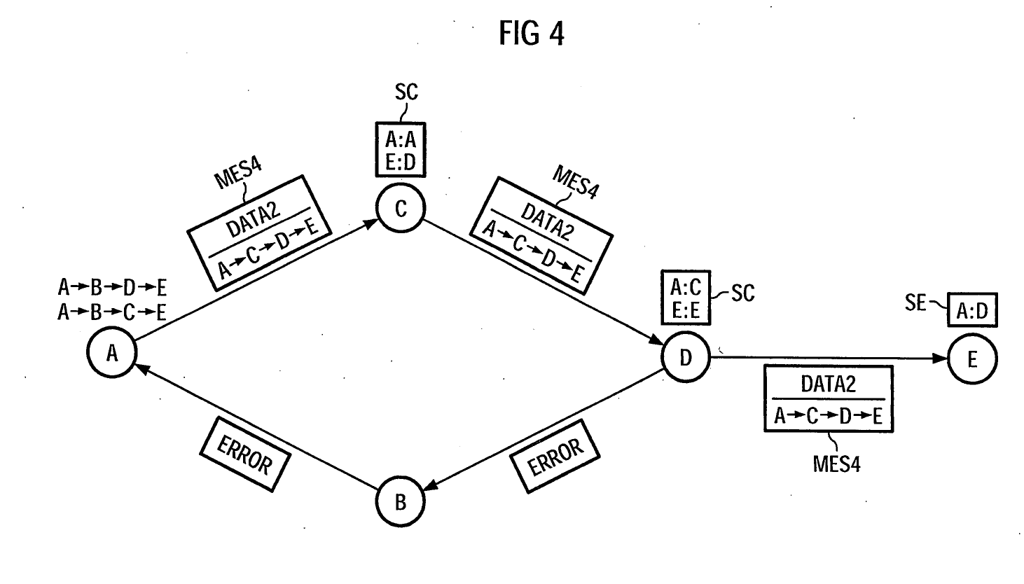

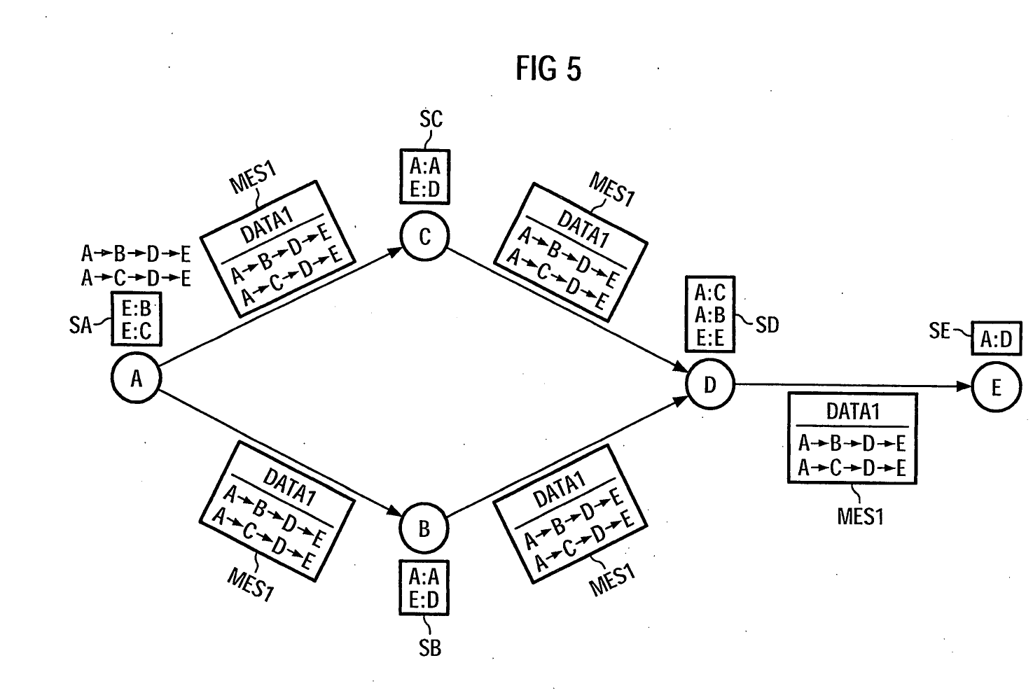

FIG. 4 illustrates the case in which not only path A→B→D→E but also path A→C→D→E is known to the source node A. After receiving the error report ERROR in respect of the path A→B→D→E, the source node A decides to use the path A→C→D→E for message transmission to the destination node E. Therefore the source node A sends a message MES4 containing the information DATA2, during whose transmission an error occurred, and the specification of the path A→C→D→E. After analyzing the message MES4, the node C stores identification information relating to its adjacent node along the path in the direction of the source node A, i.e. the source node A, and relating to its adjacent node along the path in the direction of the destination node E, i.e. the node D, in the memory SC and forwards the message MES4 to the node D. Likewise, the node D stores identification information relating to the two nodes C and E in the memory SD, while the destination node E stores identification information relating to the node D in the memory SE and the source node A stores identification information relating to the node C in the memory SA. The source node A can subsequently send messages to the destination node E via the path A→C→D→E without specifying the path to be used.

Whereas in FIG. 4 the path A→C→D→E was first initialized after the source node A received the error report ERROR relating to the path A→B→D→E, it is also possible for the initialization of the two paths and A→C→D→E and A→B→D→E to be carried out in parallel as shown in FIG. 5. In order to achieve this, the source node A sends the message MES1 as per FIG. 1, wherein the message MES1 contains the specification of the path A→C→D→E in addition to the information DATA1 and the specification of the path A→B→D→E. Two items of identification information are therefore stored in the memory SA of the source node A for the adjacent nodes in the direction of the destination node, i.e. the identification information relating to the two nodes B and C. The storage of identification information in the memories SB and SC of the nodes B and C takes place as described above. The node D, via which the paths A→B→D→E and A→C→D→E run, stores identification information relating to different adjacent nodes, i.e. the nodes B and C, for the two paths in the memory SD. After initialization of both paths A→B→D→E and A→C→D→E, the source node A can now alternatively send messages via one of the two paths A→B→D→E and A→C→D→E to the destination node E by addressing the relevant message to the node B or the node C. The decision which path to use can be made on the basis of criteria such as the length of the paths, the time delay during path determination, on the basis of transmission quality on paths or even on the basis of the age of the paths. When the source node has decided which path to use, it can optionally add to the message by including information about which of the paths must be used when forwarding, in addition to specifying the destination node in the message. However, it is also possible for a node, knowing a plurality of nodes for forwarding a message to a destination node, to make a decision about the path to be used.

The use of a plurality of paths as per FIG. 4 or 5 has the advantage that, in the event that it is no longer possible fully to perform a message transmission via one of the paths because a connection between two adjacent nodes of the path is interrupted, another path can be used. However, a new path must be determined if no other path is available, wherein transmission resources are required in order to send routing messages for path determination.

The method economizes transmission resources in two ways: as a result of the possibility of using a plurality of paths, the number of routing messages which are utilized for path determination is reduced. As a result of storing the adjacent nodes in each node via which a path runs, a specification of the path is not required when transmitting a message over the path concerned, thereby economizing redundant signaling information.

If a node received a message which was directed from the source node to the destination node via another node which it has not stored in its memory as an adjacent node on the side of the source node, it can store this node instead of the stored node. This ensures that a stored path back to the source node can be used. This also has the advantage that the path can be changed without the source node having to know about the change.

In radially symmetric networks in particular, many messages are forwarded primarily by nodes which are near to the center. Parts of a newly determined path toward the center from one source node are therefore also suitable for a path toward the center from another source node. Consequently, a node which has obtained knowledge of a new path to a destination node, e.g. by storing the adjacent node in the direction of this node in its memory during a message transmission along the new path, can forward messages of all source nodes which are addressed to this destination node via the new path. This is advantageous because current information about paths is used and old paths are updated as a result of this. If a path is not used for a specific period, the nodes can delete from their memories the identification information which relates to the adjacent nodes and is assigned to this path.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for transmitting information in a communication system having a plurality of nodes, comprising:
conveying a message from a source node to a destination node along a path, via at least one intermediate node, the message being conveyed such that the source node and each intermediate node transfer the message to an adjacent node in a direction of the path, from a transferor node to a transferee node, the message being conveyed with information specifying the path; and
using the information specifying the path at least one intermediate node to identify and store identification information relating to which two nodes are adjacent to the intermediate node, along the path.

14. The method as claimed in claim 13, wherein
the information specifying the path is sent by the source node.

15. The method as claimed in claim 13, wherein
at least one further message is conveyed without information specifying the path, and
the at least one further message is transmitted from the source node to the destination node via the path using stored identification information relating which two nodes are adjacent to the intermediate node.

16. The method as claimed in claim 15, wherein
following a failed transmission of the at least one further message from the source node to the destination node, a message including the information specifying the path is sent from the source node.

17. The method as claimed in claim 13,
wherein the path is determined based on positional relationships between nodes of the communication system.

18. The method as claimed in claim 13,
wherein all intermediate nodes via which the path runs receive the message containing the information specifying the path and store identification information relating to the two nodes adjacent to the intermediate node.

19. The method as claimed in claim 13,
wherein a plurality of paths exist from the source node to the destination node,
at least one intermediate node receives a message containing information specifying a first path and containing information specifying a second path, and
the intermediate node stores identification information relating to which two nodes are adjacent to the intermediate node along the first path and stores identification information relating to which two nodes are adjacent to the intermediate node along the second path.

20. The method as claimed in claim 13, wherein if a transferee node receives a message from a transferor node about which it has not stored any identification information, then the transferee node stores identification information about the transferor node.

21. The method as claimed in claim 14, wherein
at least one further message is conveyed without information specifying the path, and
the at least one further message is transmitted from the source node to the destination node via the path using stored identification information relating which two nodes are adjacent to the intermediate node.

22. The method as claimed in claim 21, wherein
following a failed transmission of the at least one further message from the source node to the destination node, a message including the information specifying the path is sent from the source node along the path.

23. The method as claimed in claim 22,
wherein the information specifying the path is determined based on positional relationships between nodes of the communication system.

24. The method as claimed in claim 23,
wherein all intermediate nodes via which the path runs receive the message containing the information specifying the path and store identification information relating to the two nodes adjacent to the intermediate node.

25. The method as claimed in claim 24,
wherein a plurality of paths exist from the source node to the destination node,
at least one intermediate node receives a message containing information specifying a first path and containing information specifying a second path, and
the intermediate node stores identification information relating to which two nodes are adjacent to the intermediate node along the first path and stores identification information relating to which two nodes are adjacent to the intermediate node along the second path.

26. The method as claimed in claim 25, wherein if a transferee node receives a message from a transferor node about which it has not stored any identification information, then the transferee node stores identification information about the transferor node.

27. The method as claimed in claim 26, wherein
a plurality of paths exist from the source node to the destination node,
at least one intermediate node receives information specifying a first path and information specifying a second path different from the first path, and
the intermediate node stores identification information relating to which two nodes are adjacent to the intermediate node along the first path and stores identification information relating to which two nodes are adjacent to the intermediate node along the second path.

28. An intermediate node in a communication system, comprising:
a receiver to receive a message as it is being conveyed from a source node to a destination node along a path via at least one intermediate node, the message being conveyed such that the source node and each intermediate node transfer the message to an adjacent node in a direction of the path, from a transferor node to a transferee node, the message being conveyed with information specifying the path;
means for identifying and storing identification information relating to which two nodes are adjacent to the intermediate node along the path; and
a transmitter to transfer the message to the transferee node in a direction of the path.

29. The node as claimed in claim 28, wherein
the node receives a message from a transferor node about which it has not stored any identification information, and
the node further comprises means for storing identification information about the transferor node.

30. The node as claimed in claim 29, wherein
a plurality of different paths exist from the source node to the destination node,
the node is aware of a first path and unaware of a second path, and
the node further comprises:
means for receiving information specifying the second path; and
means for storing identification information relating to which two nodes are adjacent to the intermediate node along the second path.
